(19) United States
(12) Patent Application Publication
(10) Pub. No.: US 2016/0283102 A1
(43) Pub. Date: Sep. 29, 2016

(54) DISPLAY CONTROL METHOD, COMPUTER-READABLE RECORDING MEDIUM, AND DISPLAY CONTROL APPARATUS

(71) Applicant: FUJITSU LIMITED, Kawasaki-shi (JP)

(72) Inventors: Bin Chen, MACHIDA (JP); Yusuke Yasukawa, Yokohama (JP); Yoshihiko MURAKAWA, Yokohama (JP); Keiju Okabayashi, Sagamihara (JP)

(73) Assignee: FUJITSU LIMITED, Kawasaki-shi (JP)

(21) Appl. No.: 15/071,844

(22) Filed: Mar. 16, 2016

(30) Foreign Application Priority Data
Mar. 27, 2015 (JP) 2015-066942

(51) Int. Cl. G06F 3/0488; G06F 3/0484

(52) U.S. Cl. CPC G06F 3/04883; G06F 3/04845

(57) ABSTRACT

A display control method executed by a computer, the display control method including detecting a touch position of an object and a slide locus of the touch position on a display screen displayed by a display device, determining a position of a window and a size of the window based on the slide locus of the touch position, associating the window with a terminal when a first notification is received from the terminal, the first notification being a notification which the computer received for the first time after the determining, and displaying an image received from the associated terminal in the window determined based on the determined position and the determined size of the window.

### CROSS-REFERENCE TO RELATED APPLICATION

This application is based upon and claims the benefit of priority of the prior Japanese Patent Application No. 2015-066942, filed on Mar. 27, 2015, the entire contents of which are incorporated herein by reference.

### FIELD

The embodiments discussed herein are related to controlling a display device.

### BACKGROUND

For example, at a meeting of a plurality of persons, an attempt is sometimes made to share the information held in the smartphones of the individual persons. In such a case, it is difficult to look at the screens of each other's smartphones.

Thus, if a display device having a large display surface is provided, and each of the screens of the individual smartphones is displayed on the display surface, it is possible for all the persons involved to view the information with each other.

However, the display location of each of the smartphones on the display surface differs depending on the situation.

Related-art techniques are disclosed in Japanese Laid-open Patent Publication No. 2010-26327, and Japanese Laid-open Patent Publication No. 11-338458.

### SUMMARY

According to an aspect of the invention, a display control method executed by a computer, the display control method including detecting a touch position of an object and a slide locus of the touch position on a display screen displayed by a display device, determining a position of a window and a size of the window based on the slide locus of the touch position, associating the window with a terminal when a first notification is received from the terminal, the first notification being a notification which the computer received for the first time after the determining, and displaying an image received from the associated terminal in the window determined based on the determined position and the determined size of the window.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a display system;

FIG. 2 is a diagram illustrating an example of a module configuration of a display control apparatus;

FIG. 3 is a diagram illustrating an example of a distribution processing flow;

FIG. 4 is a diagram illustrating an example of touch operation and display;

FIG. 5 is a flowchart illustrating an example of a main processing flow;

FIG. 6 is a diagram illustrating an example of touch operation and display;

FIG. 7 is a flowchart illustrating an example of a main processing flow;

FIG. 8 is a diagram illustrating an example of touch operation and display;

FIG. 9 is a flowchart illustrating an example of a main processing flow;

FIG. 10 is a diagram illustrating a display example of a window frame;

FIG. 11 is a flowchart illustrating an example of a main processing flow;

FIG. 12 is a flowchart illustrating an example of a content processing flow;

FIG. 13 is a flowchart illustrating an example of a main processing flow;

FIG. 14 is a diagram illustrating an example of a module configuration of a mobile terminal apparatus;

FIG. 15 is a flowchart illustrating an example of a notification processing flow;

FIG. 16 is a flowchart illustrating an example of a screen data transmission flow;

FIG. 17 is a flowchart illustrating an example of a content transmission flow;

FIG. 18 is a diagram illustrating an example of a hardware configuration of the mobile terminal apparatus; and

FIG. 19 is a functional block diagram of a computer.

### DESCRIPTION OF EMBODIMENTS

According to an aspect of the present disclosure, it is desirable to make it possible to easily associate a window frame disposed on the display surface of a display device with a terminal.

### First Embodiment

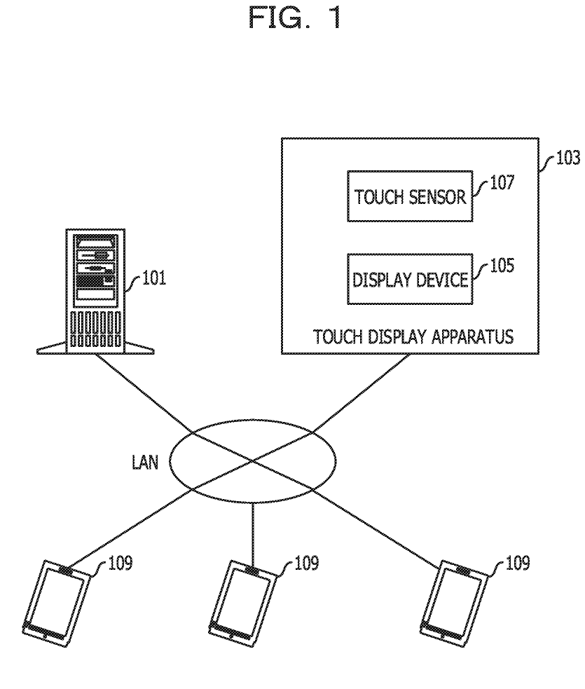

FIG. 1 illustrates an example of a configuration of a display system. A display control apparatus 101 controls a touch display apparatus 103 via a local area network (LAN). The touch display apparatus 103 includes a display device 105 and a touch sensor 107. Also, the display control apparatus 101 is coordinated with the mobile terminal apparatuses 109 via a LAN. The mobile terminal apparatuses 109 are coupled to the display control apparatus 101 via a wireless LAN.

The display control apparatus 101 may control a plurality of touch display apparatuses 103. If the plurality of touch display apparatus 103 is an integrated multi-display device, the display control apparatus 101 performs display processing and detects a touch position based on the position of a world coordinate system.

In this regard, in such an environment, it is assumed that various kinds of coordinated operation is performed between the mobile terminal apparatuses 109 and the display control apparatus 101. For example, the mobile terminal apparatuses 109 may send a coordination request to the display control apparatus 101 so that the mobile terminal apparatuses 109 and the display control apparatus 101 perform various kinds of coordinated operation. The display control apparatus 101 may detect the mobile terminal apparatuses 109 of persons who have entered a meeting room and automatically deliver a specific program to the mobile terminal apparatuses 109. The mobile terminal apparatuses 109 may automatically start a received specific program. The mobile terminal apparatuses 109 and the display control apparatus 101 may synchronize data and processes. The operation on the mobile terminal apparatus 109 may control the processing in the display control apparatus 101. Alternatively, the operation on the display control apparatus 101 may control the processing in the mobile terminal apparatuses 109.

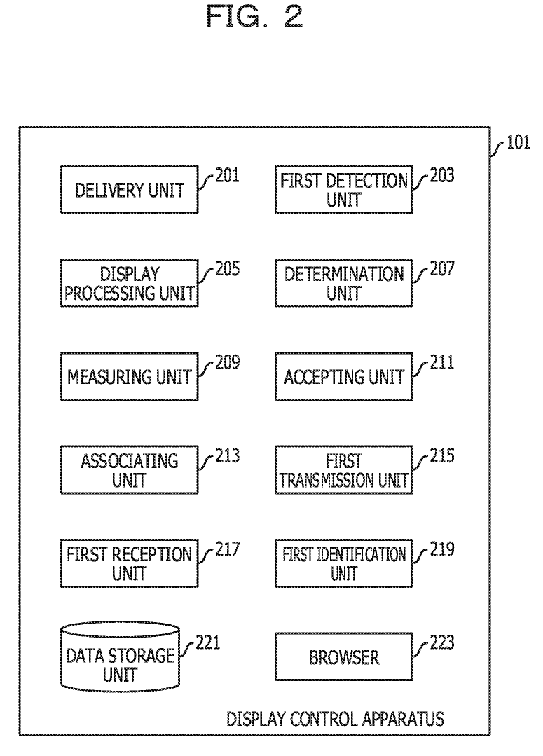

FIG. 2 illustrates an example of a module configuration of the display control apparatus 101. The display control apparatus 101 includes a delivery unit 201, a first detection unit 203, a display processing unit 205, a determination unit 207, a measuring unit 209, an accepting unit 211, an associating unit 213, a first transmission unit 215, a first reception unit 217, a first identification unit 219, a data storage unit 221, and a browser.

The delivery unit 201 delivers an application program to the mobile terminal apparatuses 109. The first detection unit 203 detects a touch position on the touch sensor 107. Further, the first detection unit 203 detects a slide locus. The display processing unit 205 performs display processing on the display device 105. The determination unit 207 determines a position and a size of a tentative window frame. The measuring unit 209 measures time for time out. The accepting unit 211 accepts an instruction from a user. The associating unit 213 associates a window frame with a corresponding one of the mobile terminal apparatuses 109. The first transmission unit 215 transmits various kinds of data to the mobile terminal apparatuses 109. The first reception unit 217 receives various kinds of data from the mobile terminal apparatus 109. The first identification unit 219 identifies the identifier of one of the mobile terminal apparatuses 109 included in the accepted notification. The data storage unit 221 stores data that associates the window frame with a corresponding one of the mobile terminal apparatuses 109. The browser 223 displays a content screen.

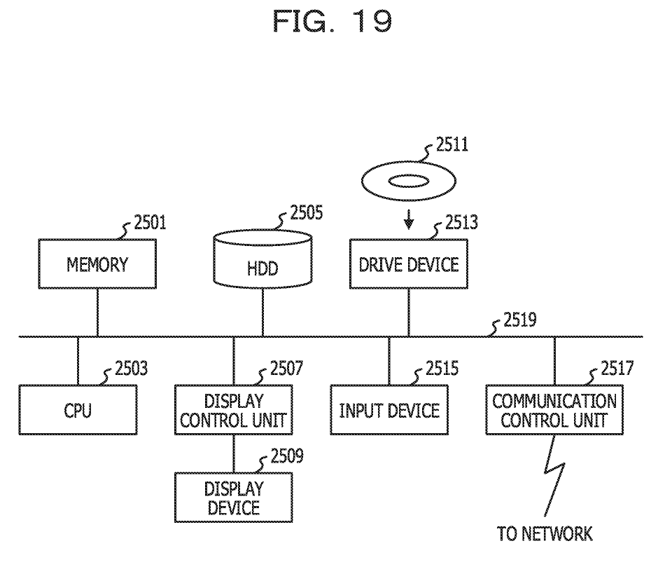

The above-described delivery unit 201, first detection unit 203, display processing unit 205, determination unit 207, measuring unit 209, accepting unit 211, associating unit 213, first transmission unit 215, first reception unit 217, first identification unit 219 and browser 223 are achieved using the hardware resources (for example, FIG. 19) and the programs that causes a processor to execute the processing described below.

The above-described data storage unit 221 is achieved using the hardware resources (for example, FIG. 19).

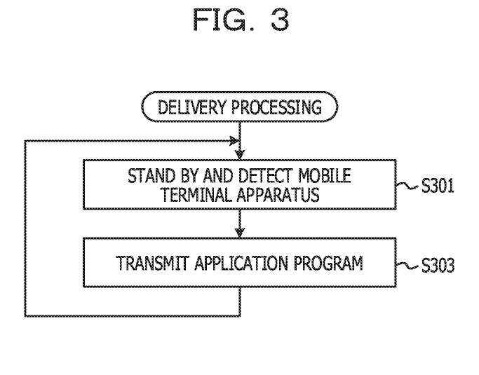

First, a description will be given of distribution processing of an application program, which is executed by the display control apparatus 101. FIG. 3 illustrates an example of the distribution processing flow. The delivery unit 201 stands by, and detects a mobile terminal apparatus 109 that has approached (S301). The delivery unit 201 detects the mobile terminal apparatus 109, for example by near field communication or a wireless LAN. The delivery unit 201 transmits an application program to the mobile terminal apparatus 109 (S303). A description will be given of the application program.

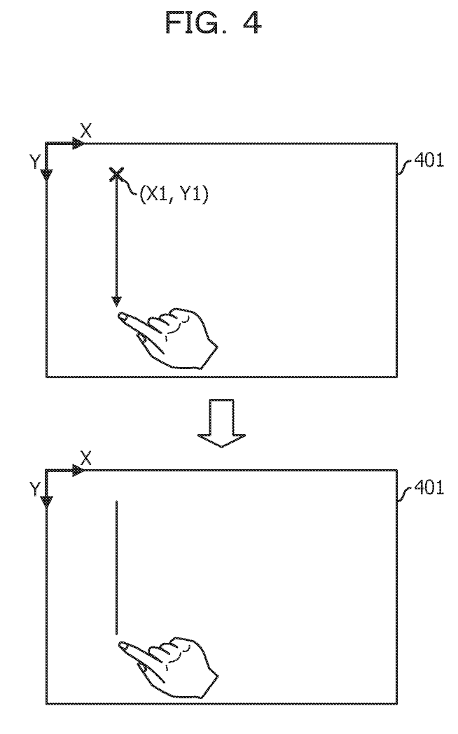

FIG. 4 illustrates an example of touch operation and display. In this example, the reference point in the coordinate system of a display surface 401 is an upper left end point of the display surface 401. The positive direction of the X-coordinate is set rightward. The positive direction of the Y-coordinate is set downward. In this example, a user touches the display surface 401 so as to draw a rectangle corresponding to a window frame to be set in order to give an instruction on the position and the size of the window frame. The user longitudinally slides a touch position so as to draw the left side of a rectangle so that the left side is displayed based on the locus of a touch position. When the user has changed the slide direction to the right, the lower left end point of the window frame is identified. If a slide direction other than downward or rightward is detected, it is considered as a cancel instruction.

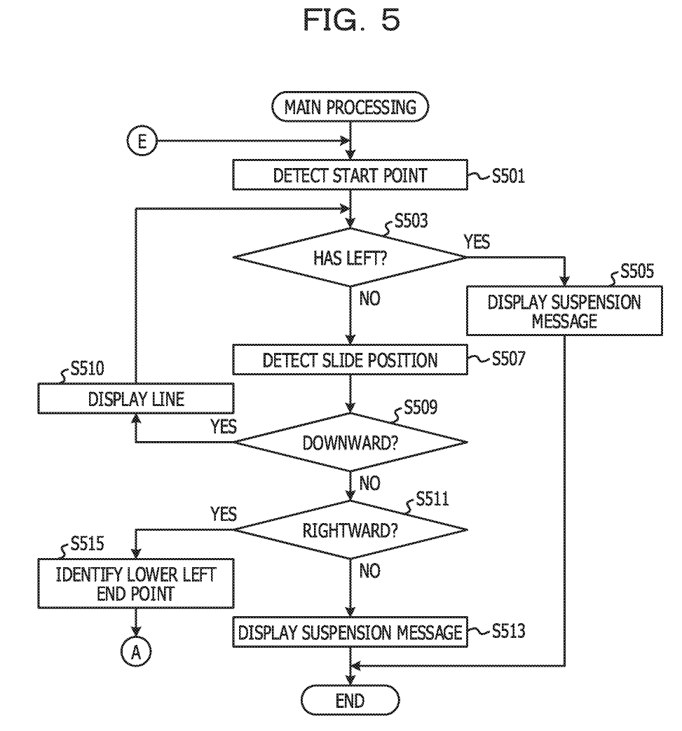

FIG. 5 illustrates an example of the main processing flow. The first detection unit 203 detects the first touch position, that is to say, a start point (X1, Y1) (S501). The first detection unit 203 determines whether or not the touching finger has left the display surface 401, that is to say, whether the touch has been completed (S503). If the display processing unit 205 determines that the touching finger has left, the display processing unit 205 displays a suspension message (S505) and terminates the main processing.

If determined that the touching finger has not left, the first detection unit 203 detects the position of the slide destination (hereinafter referred to as a slide position) (S507). If the touch position is not changed, the first detection unit 203 stands by without change. The first detection unit 203 determines whether or not the operation is a downward slide (S509). If determined that the operation is a downward slide, the display processing unit 205 displays a downward line (S510). The processing then returns to S503, and the above-described processing is repeated.

If determined that the operation is not a downward slide, the first detection unit 203 determines whether or not the operation is a rightward slide (S511). If determined that the operation is not a rightward slide, the display processing unit 205 displays a suspension message (S513), and terminates the main processing.

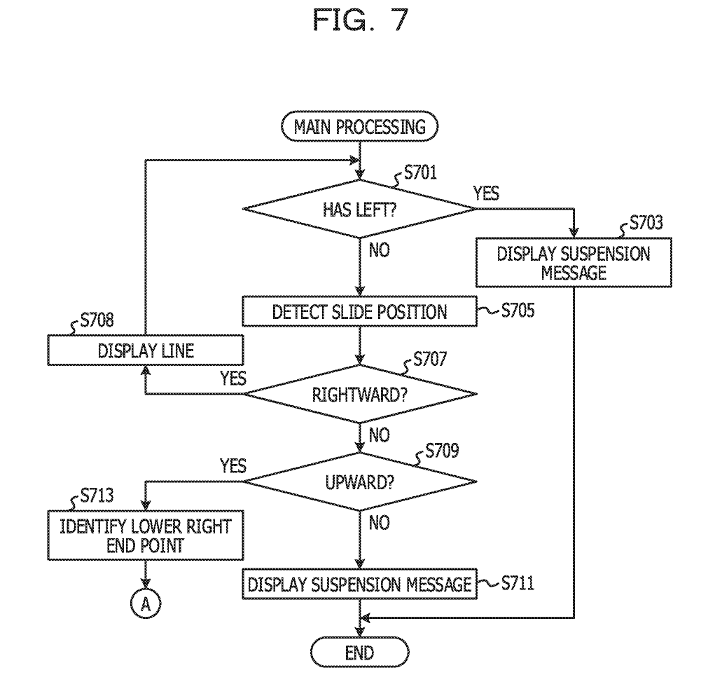

If determined that the operation is a rightward slide, the first detection unit 203 identifies the touch position at which movement has been changed to the right direction as the lower left end point (X2, Y2) (S515). The processing then proceeds to the processing of S701 illustrated in FIG. 7 through connector A.

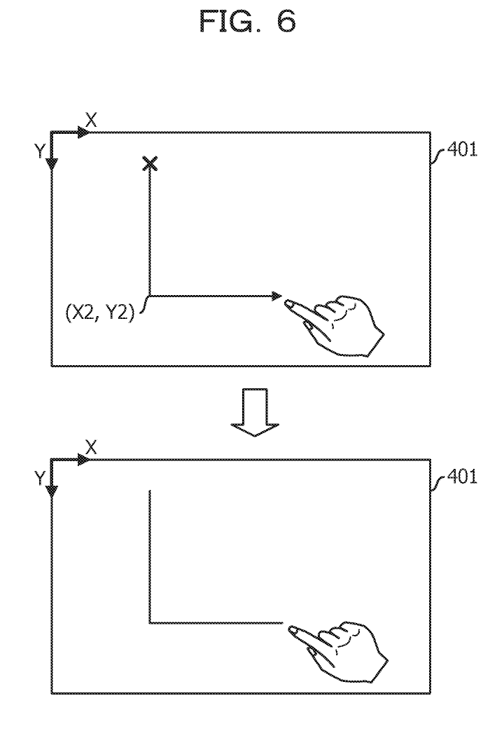

FIG. 6 illustrates a touch operation after the lower left end point (X2, Y2) of the window frame is identified. The user slides the touch position rightward so as to draw the lower side of the rectangle so that the lower side is displayed based on the locus of the touch position. When the user has changed the slide direction to the up direction, the lower right end point of the window frame is identified. If a slide direction other than rightward or upward is detected, it is considered as a cancel instruction.

Next, a description will be given of FIG. 7. The first detection unit 203 determines whether or not the touching finger has left, that is to say, whether or not the touch has been completed (S701). If the display processing unit 205 has determined that the touching finger has left, the display processing unit 205 displays a suspension message (S703) and terminates the main processing.

If determined that the touching finger has not left, the first detection unit 203 detects the slide position (S705). If the touch position has not been changed, the first detection unit 203 stands by without change. The first detection unit 203 then determines whether or not the operation is a rightward slide (S707). If determined that the operation is a rightward slide, the display processing unit 205 displays a rightward line (S708). The processing then returns to S701, and the above-described processing is repeated.

If determined that the operation is not a rightward slide, the first detection unit 203 determines whether or not the operation is an upward slide (S709). If determined that the operation is not an upward slide, the display processing unit 205 displays a suspension message (S711) and terminates the main processing.

If determined that the operation is an upward slide, the first detection unit 203 identifies the touch position that has moves upward as the lower right end point (X3, Y3) (S713). The processing then proceeds to the processing of S901 through connector B.

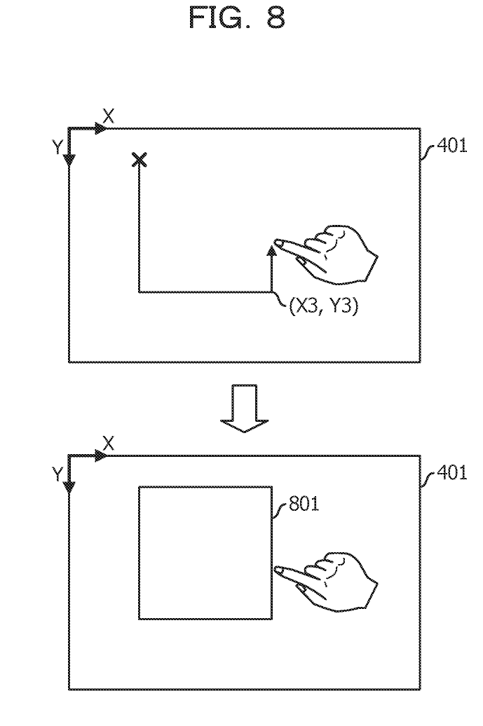

FIG. 8 illustrates a touch operation after the lower right end point (X3, Y3) of the window frame was identified. When the lower left end point of the window frame is identified, a tentative window frame 801 is displayed. At this point in time, if the finger leaves the display surface 401, the window frame is fixed. In this regard, while the finger is sliding on the tentative window frame 801, the window frame will not be fixed. If the finger slides to a position that is out of the tentative window frame 801, the operation is considered as a cancel instruction.

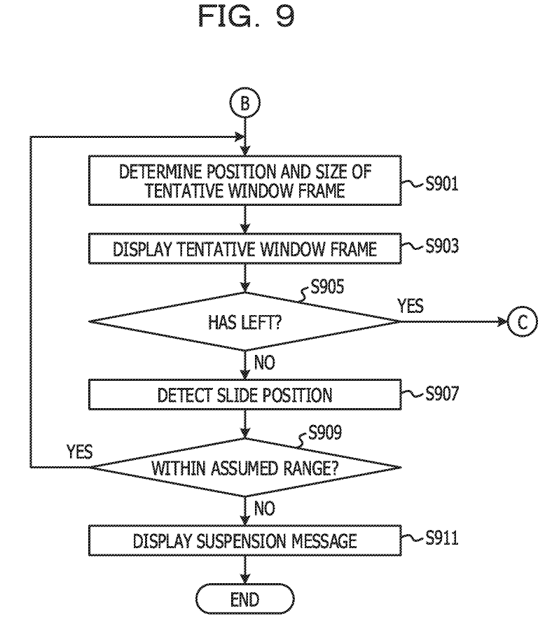

Next, a description will be given of FIG. 9. The determination unit 207 determines the position and the size of the tentative window frame 801 (S901). The position of the tentative window frame 801 is identified by the start point (X1, Y1), which is the lower left end point. Also, the size of the tentative window frame 801 is identified by a height and a width. The height is obtained by subtracting the Y-coordinate (Y1) of the start point from the Y-coordinate (Y3) of the lower right end point. Alternatively, height may be obtained by subtracting the Y-coordinate (Y1) of the start point from the Y-coordinate (Y2) of the lower left end point. The width is obtained by subtracting the X-coordinate (X1) of the start point from the X-coordinate (X3) of the lower right end point. Alternatively, the width may be obtained by subtracting the X-coordinate (X2) of the lower left end point from the X-coordinate (X3) of the lower right end point.

The display processing unit 205 displays the tentative window frame 801 in accordance with the position and the size of the tentative window frame 801 (S903). The display processing unit 205 displays the tentative window frame 801 in a mode different from that of the fixed window frame (for example, with lower brightness).

The first detection unit 203 determines whether or not the touching finger has left, that is to say, whether or not the touch has been completed (S905). If determined that the touching finger has not left, the first detection unit 203 detects the slide position (S907). The first detection unit 203 then determines whether or not the slide position is within an assumed range (S909). If the slide position is not a predetermined length or more away from the tentative window frame 801, the first detection unit 203 determines that the slide position is within the assumed range. If the slide position is a predetermined length or more away from the tentative window frame 801, the first detection unit 203 determines that the slide position is not within the assumed range.

If determined that the slide position is not within the assumed range, the display processing unit 205 displays a suspension message (S911), and terminates the main processing.

If determined that the slide position is within the assumed range, the processing returns to the processing illustrated in S901, and the above-described processing is repeated.

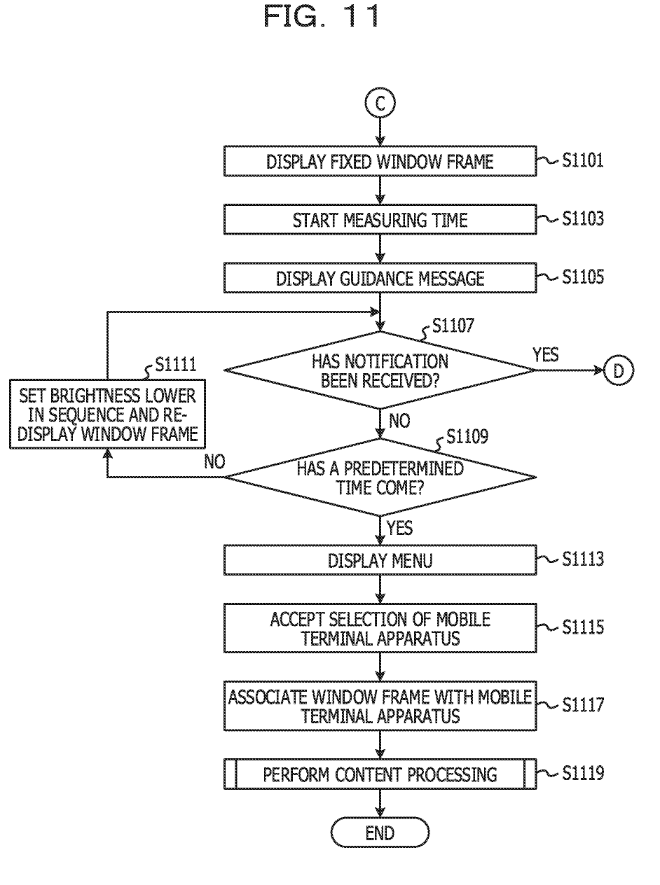

Returning to the description of the processing illustrated in S905, if determined that the touching finger has left, the processing proceeds to the processing of S1101 illustrated in FIG. 11 through connector C.

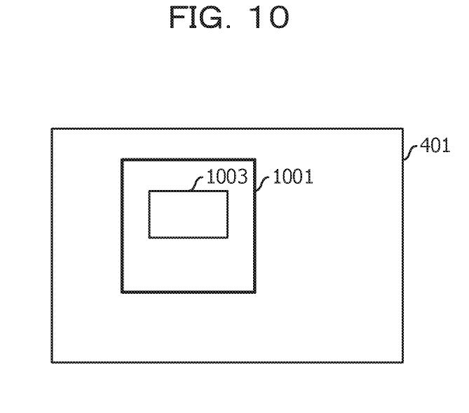

FIG. 10 illustrates a display example of the window frame. In this example, a guidance window 1003 is displayed on the fixed window frame 1001. In the guidance window 1003, a guidance message is displayed that prompts an instruction operation (in this example, a shaking operation of the mobile terminal apparatus 109, hereinafter referred to as a shake operation) in one of the mobile terminal apparatuses 109 to be associated with the fixed window frame 1001.

Next, a description will be given of FIG. 11. The display processing unit 205 displays the fixed window frame 1001 in accordance with the position and the size of the tentative window frame 801 determined in S901 (S1101). That is to say, the display processing unit 205 changes from the display of the tentative window frame 801 to the display of the fixed window frame 1001. The fixed window frame 1001 is displayed in a mode different (for example, high brightness) from that of the tentative window frame 801.

At this point in time, the measuring unit 209 starts measuring time for time out (S1103). The display processing unit 205 then displays the guidance window 1003 including the guidance message (S1105). The display control apparatus 101 may output the guidance message by sound.

The first reception unit 217 determines whether or not a notification including the identifier of the mobile terminal apparatus 109 has been received from the mobile terminal apparatus 109 (S1107). If determined that the notification has not been received, the measuring unit 209 determines whether or not a predetermined time has come (S1109). If a predetermined time has not come, the display processing unit 205 re-displays the window frame 1001 by setting the brightness lower in sequence (S1111). The processing then returns to S1107, and the above-described processing is repeated. In this manner, it is easy to know the remaining time until time out by feeling.

If determined that a predetermined time has come without receiving the above-described notification, the display processing unit 205 displays a menu that prompts selection of one of the mobile terminal apparatuses 109 (S1113). In this example, it is assumed that the display control apparatus 101 holds the information on the mobile terminal apparatuses 109 located in the vicinity in advance. When the accepting unit 211 accepts the selected one of the mobile terminal apparatuses 109 (S1115), the associating unit 213 stores data associating the window frame 1001 with the corresponding one of the mobile terminal apparatuses 109 in the data storage unit 221 (S1117). The associating unit 213 stores data that associate, for example a window ID, a window position, and the size of a window with the identifier of the mobile terminal apparatus 109 in the data storage unit 221. The mobile terminal apparatus 109 then performs content processing (S1119).

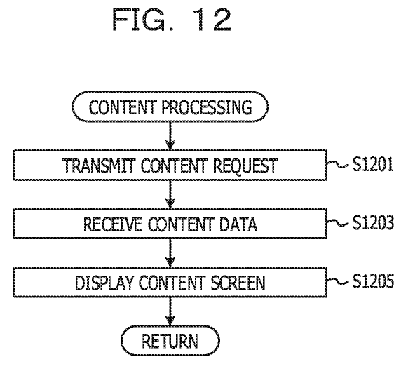

FIG. 12 illustrates an example of a content processing flow. The first transmission unit 215 transmits a content request to the mobile terminal apparatus 109 associated with the window frame 1001 (S1201). The first reception unit 217 receives content data from the mobile terminal apparatus 109 (S1203). The display processing unit 205 displays a content screen drawn by the browser 223 on the display device 105 (S1205).

Next, a description will be given of FIG. 11 again. When the content processing illustrated in S1119 is completed, the main processing is terminated. In this regard, the content processing illustrated in S1119 is an example of the processing using the association of the window frame with the mobile terminal apparatus 109. Accordingly, when other processing is performed in place of the content processing, the content processing illustrated in this example may be omitted.

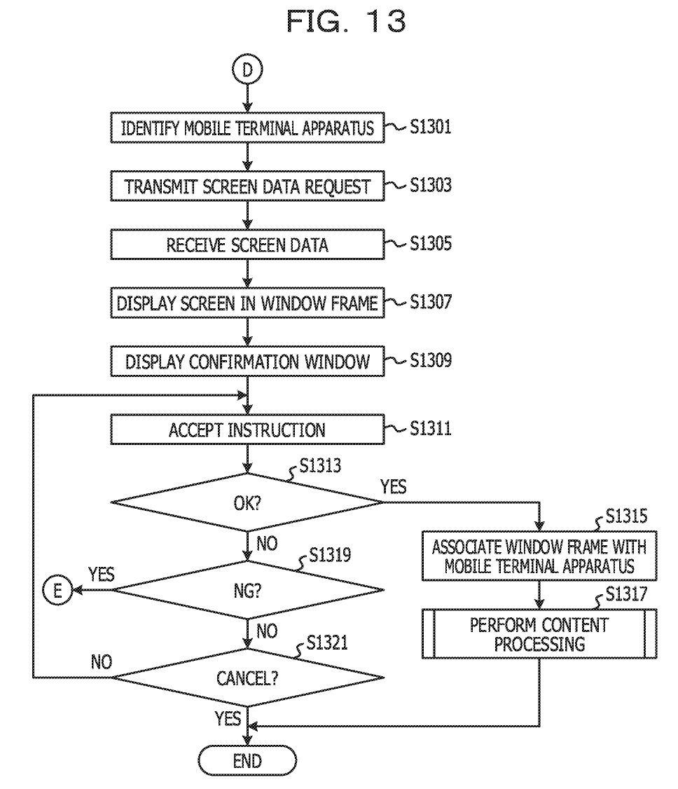

A description will be given of the processing illustrated in S1107 again. If determined that a notification including the identifier of the mobile terminal apparatus 109 is received from the mobile terminal apparatus 109, the processing proceeds to the processing of S1301 illustrated in FIG. 13 through connector D.

The first identification unit 219 identifies the identifier of the mobile terminal apparatus 109 included in the received notification (S1301). The first transmission unit 215 transmits a screen data request to the mobile terminal apparatus 109 identified by the identifier of the mobile terminal apparatus 109 (S1303).

When the first reception unit 217 receives the screen data (S1305), the display processing unit 205 displays the screen based on the screen data in the window frame (S1307). Further, the display processing unit 205 displays a confirmation window (S1309). The confirmation window includes a message that prompts confirmation of the association of the window frame with the mobile terminal apparatus 109. The confirmation window includes an “OK” button for acknowledging the association of the window frame with the mobile terminal apparatus 109, an “NG” button for instructing to associate the window frame with a mobile terminal apparatus 109 over again, and a “cancel” button for canceling the setting of the window frame.

The accepting unit 211 accepts the instruction (S1311). The accepting unit 211 determines whether or not the accepted instruction is “OK” (S1313). If determined that the accepted instruction is “OK”, the associating unit 213 stores the data associating the window frame with the terminal to which the notification was sent in the data storage unit 221 (S1315). The associating unit 213 stores data associating, for example, a window ID, a window position, and a window size with the identifier of the mobile terminal apparatus 109 identified in S1301 in the data storage unit 221. The mobile terminal apparatus 109 performs the above-described content processing (S1317).

If determined that the accepted instruction is not “OK”, the accepting unit 211 determines whether or not the accepted instruction is “NG” (S1319). If determined that the accepted instruction is “NG”, the processing returns the processing of S501 illustrated in FIG. 5 through connector E, and the above-described processing is repeated.

If determined that the accepted instruction is not “NG”, the accepting unit 211 determines whether or not the accepted instruction is “cancel” (S1321). If determined that the accepted instruction is “cancel”, the main processing is terminated. If determined that the accepted instruction is not “cancel”, the instruction is considered as an invalid instruction, the processing returns to S1311, and an instruction is accepted again. The description on the operation of the display control apparatus 101 will be completed by the above.

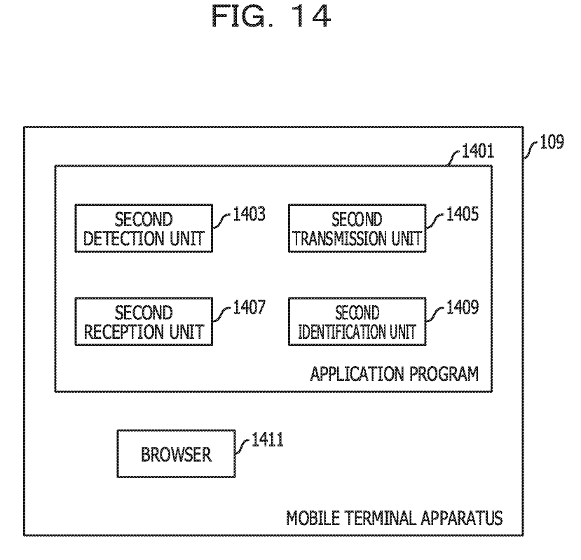

Next, a description will be given of operation of the mobile terminal apparatus 109. FIG. 14 illustrates an example of a module configuration of the mobile terminal apparatus 109. The mobile terminal apparatus 109 includes an application program 1401 and a browser 1411. The application program 1401 includes a second detection unit 1403, a second transmission unit 1405, a second reception unit 1407, and a second identification unit 1409.

The application program 1401 performs various kinds of processing in the mobile terminal apparatus 109. The second detection unit 1403 detects an instruction operation (in this example, shake operation) from the user. The second transmission unit 1405 transmits various kinds of data to the display control apparatus 101. The second reception unit 1407 receives the various kinds of data from the display control apparatus 101. The second identification unit 1409 identifies screen data and content data to be sent to the display control apparatus 101. The browser 1411 generates a screen to be viewed on the mobile terminal apparatus 109.

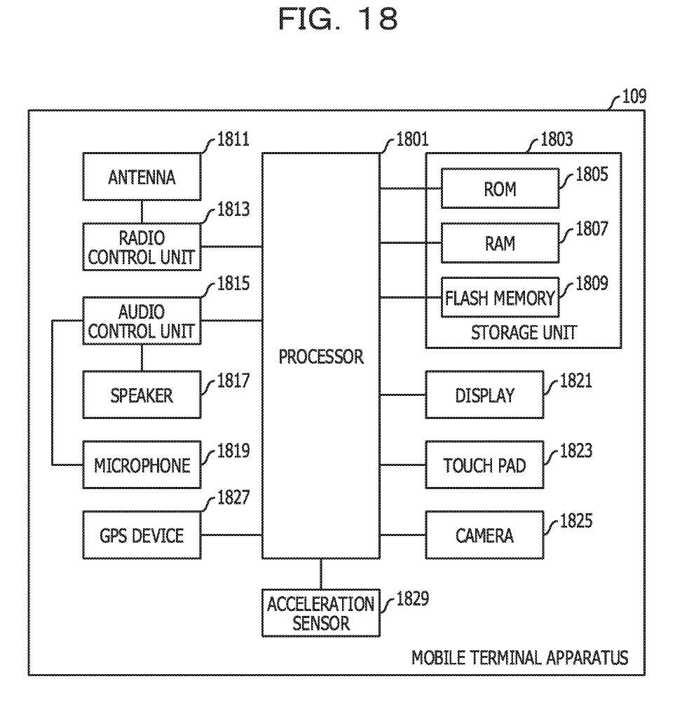

The above-described application program 1401, second detection unit 1403, second transmission unit 1405, second reception unit 1407 and second identification unit 1409 are achieved using the hardware resources (for example, FIG. 18) and the program for causing the processor 1801 to execute the processing described below.

The above-described browser 1411 is achieved using hardware resources (for example, FIG. 18).

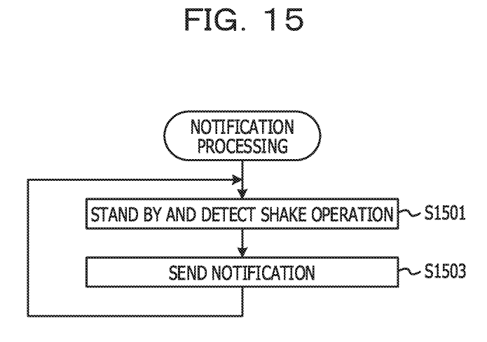

FIG. 15 illustrates an example of a notification processing flow. The second detection unit 1403 stands by and detects a shake operation (S1501). The second detection unit 1403 determines whether or not a shake operation has been carried out based on, for example a change in the acceleration measured by an acceleration sensor (FIG. 18: 1829). In this regard, the shake operation is an example of an operation when a holder of the mobile terminal apparatus 109 instructs a notification. For example, the other operations, such as a button operation, a touch operation, or the like may be used for instructing the notification. When the second detection unit 1403 detects a shake operation, the second transmission unit 1405 sends a notification including the identifier of the mobile terminal apparatus 109 to the display control apparatus 101 (S1503). The processing then returns to the processing of S1501.

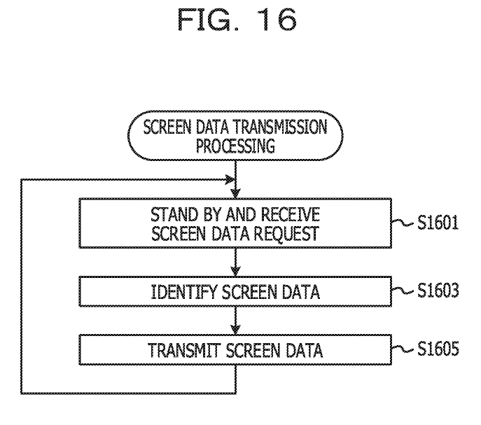

FIG. 16 illustrates an example of a screen data transmission flow. The second reception unit 1407 stands by and receives a screen data request from the display control apparatus 101 (S1601). The second identification unit 1409 identifies screen data to be sent to the display control apparatus 101 (S1603). For example, the second identification unit 1409 identifies the data of the screen recently displayed on the browser 1411. The data of the screen may be capture data. The second transmission unit 1405 transmits the identified screen data to the mobile terminal apparatus 109 (S1605). The processing then returns to the processing of S1601.

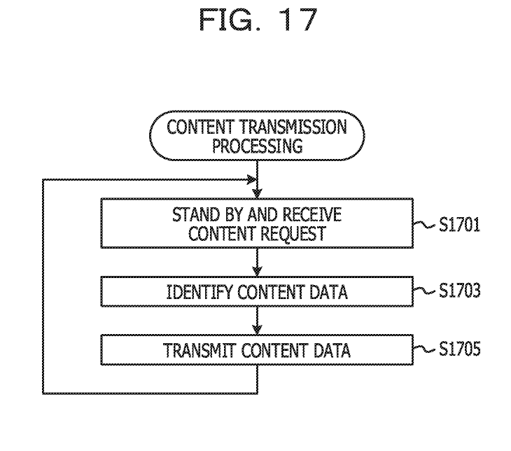

FIG. 17 illustrates an example of a content transmission flow. The second reception unit 1407 stands by and receives a content request from the display control apparatus 101 (S1701). The second identification unit 1409 identifies content data to be sent to the display control apparatus 101 (S1703). The second identification unit 1409 identifies, for example the content data held by the display control apparatus 101. The content data is, for example a Hyper Text Markup Language (HTML) file. The second transmission unit 1405 transmits the identified content data to the display control apparatus 101 (S1705). The description on the operation of the mobile terminal apparatus 109 will be completed by the above.

The display control apparatus 101 may not accept an operation that specifies the other window frame while accepting the operation of the window frame. Further, the display control apparatus 101 may set a window frame with any display angle.

The display control apparatus 101 may not accept an operation specifying the other window frame while the tentative window frame 801 is displayed.

The display control apparatus 101 may display data that identifies the mobile terminal apparatus 109 associated with the window frame 1001, or data that identifies the owner of the mobile terminal apparatus 109 in the fixed window frame 1001.

The display control apparatus 101 may receive only the notification of the first time, and may disregard the second time or later notification.

The display control apparatus 101 may disregard a notification from the mobile terminal apparatus 109 that has already been associated with any one of the window frames.

FIG. 18 illustrates an example of a hardware configuration of the mobile terminal apparatus 109. The mobile terminal apparatus 109 includes a processor 1801, a storage unit 1803, an antenna 1811, a radio control unit 1813, an audio control unit 1815, a speaker 1817, a microphone 1819, a display 1821, a touch pad 1823, a camera 1825, a GPS device 1827, and an acceleration sensor 1829.

The processor 1801 is sometimes constituted by a modem central processing unit (CPU) and an application CPU. The storage unit 1803 includes, for example a read only memory (ROM) 1805, a random access memory (RAM) 1807, and a flash memory 1809. The ROM 1805 stores, for example data and programs that are set in advance. The RAM 1807 includes, for example areas where programs and data for applications, and the like are expanded. The flash memory 1809 stores, for example programs of an operating system and applications, and the like, and further stores data at any time.

The touch pad 1823 is, for example a panel-shaped sensor disposed on the display surface of the display 1821, and accepts touch operation. The display 1821 displays various screens output by applications, for example. Specifically, the display 1821 and the touch pad 1823 are used as an integrated touch panel. A touch event is generated by touch operation on the touch pad 1823. Keys may be disposed in addition to the touch pad 1823.

The antenna 1811 receives cellular system wireless data, for example. The radio control unit 1813 performs control of wireless communication. Voice communication and data communication of telephone are carried out under the control of wireless communication.

The audio control unit 1815 performs analog-to-digital conversion and digital-to-analog conversion concerning sound data. The speaker 1817 outputs analog data as sound. The microphone 1819 converts sound into analog data.

The camera 1825 is used for capturing moving image and photo images. The GPS device 1827 measures a position. The acceleration sensor 1829 measures acceleration.

With this embodiment, it is possible to easily associate a window frame disposed on the display surface 401 of a display device with a terminal.

Also, the tentative window frame 801 is displayed before the window frame is fixed, and thus it is possible for the user to confirm the position and the size of the window frame in advance.

Also, a guidance that prompts a shake operation is output, and thus the operation procedure for associating a terminal with a window frame is easy to understand.

Also, the image received from the mobile terminal apparatus 109 is displayed in the window frame, and confirmation of association is prompted, and thus it is easy to confirm that the window frame is associated with any one of the mobile terminal apparatuses 109.

Also, when a neighboring mobile terminal apparatus 109 is detected, the application program 1401 is delivered to the mobile terminal apparatus 109, and thus it is possible to timely send a notification from a terminal.

Also, content is displayed in the window frame based on the content data received from the mobile terminal apparatus 109 associated with the window frame, and thus it is possible for the user to view the content held in the mobile terminal apparatus 109 on the display surface 401 of the display device 105.

In the above, a description has been given of an embodiment of the present disclosure. However, the present disclosure is not limited to this. For example, the above-described functional block configuration sometimes does not match the program module configuration.

Also, the above-described configuration of each of the storage areas is an example, and the present disclosure is not limited to the above-described configuration. Further, in the processing flow, unless the processing result will not be changed, the order of the processing may be changed, and a plurality of the processes may be executed in parallel.

In this regard, the above-described display control apparatus 101 is a computer apparatus. As illustrated in FIG. 19, in the computer apparatus, a memory 2501, a central processing unit (CPU) 2503, a hard disk drive (HDD) 2505, a display control unit 2507 coupled to a display device 2509, a drive unit 2513 for a removable disk 2511, an input device 2515, a communication control unit 2517 for coupling to a network are coupled through a bus 2519. The operating system (OS) and the application program for executing this embodiment are stored in the HDD 2505 and are read by the CPU 2503 from the HDD 2505 to the memory 2501. The CPU 2503 controls the display control unit 2507, the communication control unit 2517, and the drive unit 2513 in accordance with the processing contents of the application program in order to perform the predetermined operation. Also, intermediate data during the processing is mainly stored in the memory 2501, but may be stored in the HDD 2505. In the embodiment of the present disclosure, the application program for performing the above-described processing is stored in a computer-readable removable disk 2511, is distributed, and then is installed in the HDD 2505 from the drive unit 2513. The application program is sometimes installed in the HDD 2505 via a network, such as the Internet, or the like and the communication control unit 2517. Such a computer apparatus achieves the above-described various functions by the organized coordination of the above-described hardware, such as the CPU 2503, the memory 2501, and the like, and the programs, such as the OS, the application program, and the like.

The above-described embodiment of the present disclosure is summarized as follows.

A method for setting a window, according to this embodiment, includes based on a locus of a touch position on a display surface of a display device, determining a position and a size of a window frame to be disposed on the display surface, displaying the window frame on the display surface in accordance with the position and the size of the window frame, and if a notification is received from a terminal in a predetermined period, associating the window frame with the terminal.

In this manner, it is easy to associate a window frame disposed on the display surface of a display device with a terminal.

Further, before a window frame is fixed, processing for displaying a tentative window frame may be included.

In this manner, it is possible to confirm the position and the size of a window frame in advance.

Further, processing for outputting a guidance that prompts an instruction operation of the above-described notification at the terminal may be included.

In this manner, the operation procedure for associating a terminal with the window frame is easy to understand.

Further, processing for displaying an image received from the associated terminal in the window frame may be included. Also, processing for displaying a screen that prompts a confirmation of the association may be included.

In this manner, it is easy to confirm which terminal is associated with the window frame.

Further, if a neighboring terminal is detected, processing for delivering a program that performs the notification to the terminal may be included.

In this manner, it is possible to timely send a notification from a terminal.

Further, processing for displaying content in the window frame based on the content data received from the terminal associated with the window frame may be included.

In this manner, it is possible for the user to view the content held by the terminal on the display surface of the display device.

In this regard, it is possible to create a program for causing a computer or a processor to perform processing by the above-described method. The program may be stored on a computer-readable storage medium or a storage device, for example, a flexible disk, a CD-ROM, a magneto-optical disc, a semiconductor memory, a hard disk, or the like. In this regard, in general, an intermediate processing result is temporarily stored in a storage device, such as a main memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control method executed by a computer, the display control method comprising:
detecting a touch position of an object and a slide locus of the touch position on a display screen displayed by a display device;
determining a position of a window and a size of the window based on the slide locus of the touch position;
associating the window with a terminal when a first notification is received from the terminal, the first notification being a notification which the computer received for the first time after the determining; and
displaying an image received from the associated terminal in the window determined based on the determined position and the determined size of the window.

2. The display control method according to claim 1, further comprising:
displaying a tentative window before the window is fixed, the window being fixed when it is detected the object leaves the display screen after at least three vertexes of the window flame has been identified.

3. The display control method according to claim 1, further comprising:
outputting a guidance prompting an instruction operation of the first notification at the terminal.

4. The display control method according to claim 1, further comprising:
displaying information prompting confirmation of the associating when the terminal is associated with the window.

5. The display control method according to claim 1, further comprising:
when another terminal is detected based on the wireless communication, transmitting a program performing the first notification to the another terminal.

6. The display control method according to claim 1, further comprising:
displaying content in the window based on content data received from the terminal associated with the window.

7. The display control method according to claim 1, further comprising:
displaying the window on the display screen in accordance with the determined position and the determined size;
measuring time from a timing when the window has been displayed; wherein
in the associating, associating the window with a terminal when the first notification is received before a predetermined time passes from a timing when the window displayed.

8. The display control method according to claim 7, further comprising:
setting brightness of the displayed window lower according to the passage of time from the timing.

9. A computer-readable recording medium storing a program that causes a computer to execute a process, the process comprising:
detecting a touch position of an object and a slide locus of the touch position on a display screen displayed by a display device;
determining a position of a window and a size of the window based on the slide locus of the touch position;
associating the window with a terminal when a first notification is received from the terminal, the first notification being a notification which the computer received for the first time after the determining; and
displaying an image received from the associated terminal in the window determined based on the determined position and the determined size of a window.

10. A display control apparatus comprising:
a memory; and
a processor coupled to the memory and configured to:
detect a touch position of an object and a slide locus of the touch position on a display screen displayed by a display device;
determine a position of a window and a size of the window based on the slide locus of the touch position;
associate the window with a terminal when a first notification is received from the terminal, the first notification being a notification which the computer received for the first time after the determining; and
display an image received from the associated terminal in the window determined based on the determined position and the determined size of the window.
